(19) United States
(12) Patent Application Publication
(10) Pub. No.: US 2021/0244089 A1
(43) Pub. Date: Aug. 12, 2021

(54) Timed Release Storage Assembly

(71) Applicant: Kunal C. Davda, Toronto (CA)

(72) Inventor: Kunal C. Davda, Toronto (CA)

(21) Appl. No.: 16/787,634

(22) Filed: Feb. 11, 2020

(51) Int. Cl. A24F 15/00

(52) U.S. Cl. CPC A24F 15/005

(57) ABSTRACT

A timed release storage assembly for restricting access to cigarettes includes a box that has dimensions sufficient to receive a pack of cigarettes. A lid is hingedly coupled to the box and the lid is positionable between an open position to restrict access to the pack of cigarettes in the box. The locking unit disengages the lid when the locking unit is in an unlocked condition at predetermined intervals of time. A lighter is coupled to the box and the lighter produces heat when the lighter is ignited to light cigarettes for smoking. A light emitter is coupled to the box to emit light outwardly therefrom.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to timed storage devices and more particularly pertains to a new timed storage device for restricting access to cigarettes.

### (2) Description of Related Art Including Information Disclosed Under 37 CFR 1.97 and 1.98

The prior art relates to timed storage devices. The prior art discloses a cigarette box that includes a timer and a belt with dispensing holes therein for sequentially exposing cigarettes. The prior art discloses a variety of cigarette boxes that have a timed release which range between mechanical timers and programmable electronic timers. Additionally, the prior art discloses a variety of cigarette boxes that have mechanisms for vending a single cigarette at predetermined durations of time. In one instance the cigarette box has a storage compartment for storing a cigarette lighter. The most relevant prior art disclose a cigarette case that includes an electronic timer and a lighter that is integrated into the cigarette case. In none of the disclosures is the combination of a timed release, a lighter and a light emitter claimed.

### BRIEF SUMMARY OF THE INVENTION

An embodiment of the disclosure meets the needs presented above by generally comprising a box that has dimensions sufficient to receive a pack of cigarettes. A lid is hingedly coupled to the box and the lid is positionable between an open position to restrict access to the pack of cigarettes in the box. The locking unit disengages the lid when the locking unit is in an unlocked condition at predetermined intervals of time. A lighter is coupled to the box and the lighter produces heat when the lighter is ignited to light cigarettes for smoking. A light emitter is coupled to the box to emit light outwardly therefrom.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a timed release storage assembly according to an embodiment of the disclosure.

FIG. 2 is a left side phantom view of an embodiment of the disclosure.

FIG. 3 is a right side phantom view of an embodiment of the disclosure.

FIG. 4 is a front view of an embodiment of the disclosure.

FIG. 5 is a bottom view of an embodiment of the disclosure.

FIG. 6 is a schematic view of an embodiment of the disclosure.

### DETAILED DESCRIPTION OF THE INVENTION

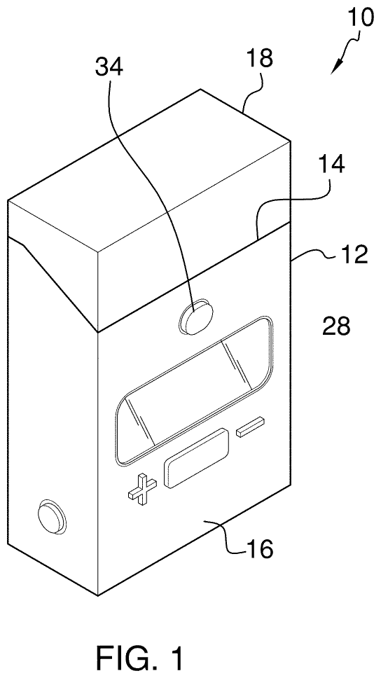

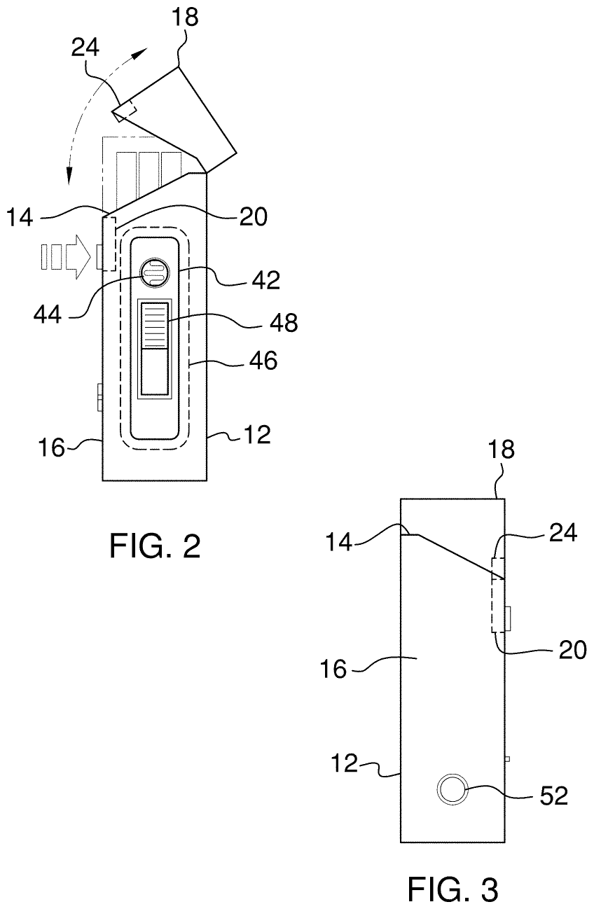

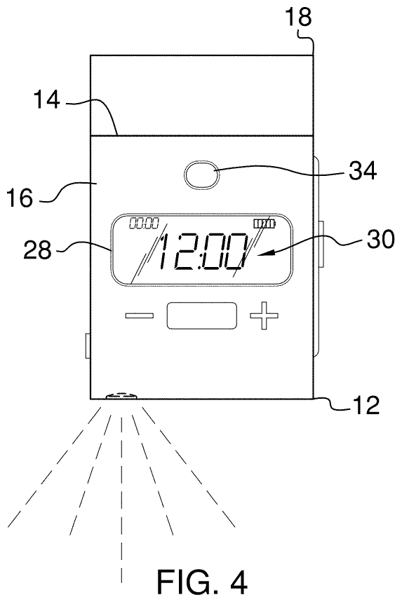

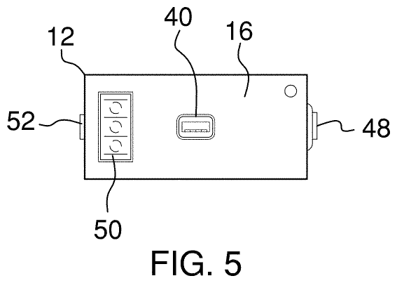

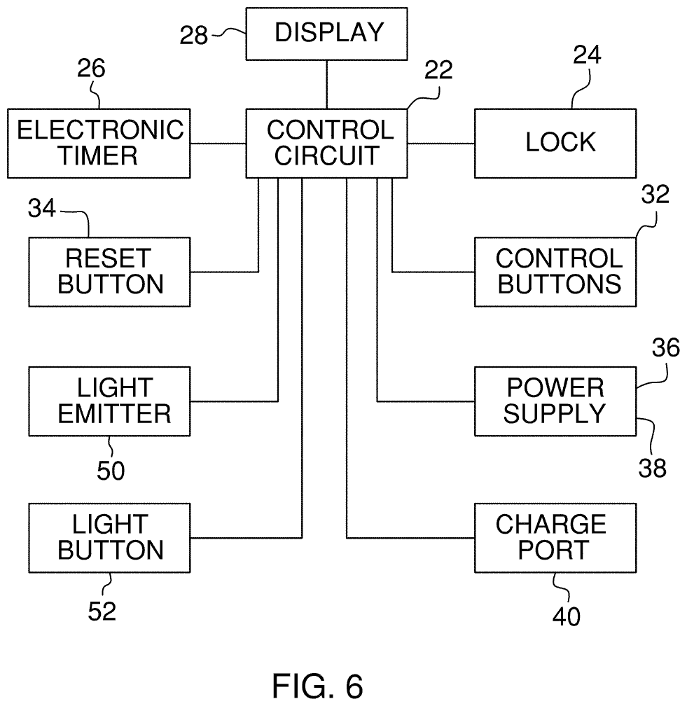

With reference now to the drawings, and in particular to FIGS. 1 through 6 thereof, a new timed storage device embodying the principles and concepts of an embodiment of the disclosure and generally designated by the reference numeral 10 will be described.

As best illustrated in FIGS. 1 through 6, the timed release storage assembly 10 generally comprises a box 12 that has dimensions sufficient to receive a pack of cigarettes. The box 12 has a top end 14 and an outer wall 16, and the top end 14 is open. A lid 18 is hingedly coupled to the box 12 and the lid 18 is positionable between an open position and a closed position. The lid 18 is positioned on the top end 14 of the box 12 and the lid 18 closes the top end 14 when the lid 18 is in the closed position.

A locking unit 20 is provided and the locking unit 20 is coupled to the box 12. The locking unit 20 engages the lid 18 when the locking unit 20 is in a locked condition to restrict access to the pack of cigarettes in the box 12. The locking unit 20 disengages the lid 18 when the locking unit 20 is in an unlocked condition. The locking unit 20 is actuated into the unlocked condition at predetermined intervals of time.

The locking unit 20 comprises a control circuit 22 that is coupled to the box 12, and the control circuit 22 receives an unlock input. A lock 24 is coupled to the box 12 and the lock 24 is electrically coupled to the control circuit 22. The lock 24 is in a normally locked condition thereby locking the lid 18. Moreover, the lock 24 is actuated to release the lid 18 when the control circuit 22 receives the unlock input. The lock 24 may comprise an electronic lock of any conventional design.

An electronic timer 26 is coupled to the box 12 and the electronic timer 26 is electrically coupled to the control circuit 22. The electronic timer 26 tracks the time of day. A display 28 is coupled to the outer wall 16 of the box 12 and the display 28 is electrically coupled to the control circuit 22. The display 28 displays numeric indicia 30 for indicating the time of day. The display 28 may be an LCD or other similar type of electronic display.

A plurality of control buttons 32 is each movably coupled to the outer wall 16 of the box 12. Each of the control buttons 32 is electrically coupled to the control circuit 22. The control buttons 32 are manipulated to program the time of day at which the control circuit 22 should receive the unlock input. The control circuit 22 may be programmed to receive the unlock input at regularly scheduled intervals throughout the day, at specific hours of the day or any combination thereof. An override button 34 is movably coupled to the box 12 and the override button 34 is electrically coupled to the control circuit 22. The lock 24 is actuated to release the lid 18 when the override button 34 is depressed thereby facilitating the box 12 to be opened at any time.

A power supply 36 is coupled to the box 12 and the power supply 36 is electrically coupled to the control circuit 22. The power supply 36 comprises at least one battery 38 that is electrically coupled to the control circuit 22. A charge port 40 is recessed into the outer wall 16 of the box 12 and the charge port 40 is electrically coupled to the at least one battery 38. The charge port 40 is electrically coupled to a power source for charging the at least one battery 38.

A lighter 42 is provided and the lighter 42 is coupled to the box 12. The lighter 42 produces heat when the lighter 42 is turned on to light cigarettes for smoking. An igniter 48 is slidably coupled to the box 12 and the igniter 48 is operationally coupled to the lighter 42. The igniter 48 turns on the lighter 42 when the igniter 48 is manipulated into an igniting position. The lighter 42 may comprise a heating coil or other type of electronic device that can produce heat sufficient to ignite tobacco.

A light emitter 50 is coupled to the box 12 to emit light outwardly therefrom. The light emitter 50 is electrically coupled to the control circuit 22. A light button 52 is movably coupled to the box 12 and the light button 52 is electrically coupled to the light emitter 50. The light button 52 turns the light emitter 50 on and off. The light emitter 50 may comprise an LED or the like.

In use, the pack of cigarettes is positioned in the box 12 and the lid 18 is closed. The control buttons 32 are manipulated to program the time of day, or duration of time, at which the lock 24 is actuated into the unlocked condition. In this way the user can regulate their consumption of cigarettes by imposing a predetermined schedule on their access to the cigarettes in the box 12. Additionally, the lighter 42 on the box 12 can be manipulated to light the cigarettes for smoking.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A timed release storage assembly being configured to be openable only at predetermined intervals of time for controlled distribution of materials contained within, said assembly comprising:
a box having dimensions sufficient to receive a pack of cigarettes;
a lid being hingedly coupled to said box, said lid being positionable between an open position and a closed position;
a locking unit being coupled to said box, said locking unit engaging said lid when said locking unit is in a locked condition wherein said locking unit is configured to restrict access to the pack of cigarettes in said box, said locking unit disengaging said when said locking unit is in an unlocked condition, said locking unit being actuated into said unlocked condition at predetermined intervals of time;
a lighter being coupled to said box, said lighter producing heat when said lighter is turned on wherein said lighter is configured to light cigarettes for smoking;
an igniter being slidably coupled to said box wherein said igniter is configured to be manipulated to a user, said igniter being operationally coupled to said lighter, said igniter turning on said lighter when said igniter is manipulated into an igniting position;
a light emitter being coupled to said box wherein said light emitter is configured to emit light outwardly therefrom; and
a light button being movably coupled to said box, said light button being electrically coupled to said light emitter, said light button turning said light emitter on and off.

2. The assembly according to claim 1, further comprising:
said box has a top end and an outer wall, said top end being open; and
said lid being positioned on said top end of said box, said lid closing said top end when said lid is in said closed position.

3. The assembly according to claim 2, wherein said locking unit comprises:
a control circuit being coupled to said box, said control circuit receiving an unlock input; and
a lock being coupled to said box, said lock being electrically coupled to said control circuit, said lock being in a normally locked condition thereby locking said lid, said lock being actuated to release said lid when said control circuit receives said unlock input.

4. The assembly according to claim 3, wherein said locking unit comprises an electronic timer being coupled to said box, said electronic timer being electrically coupled to said control circuit, said electronic timer tracking the time of day.

5. The assembly according to claim 4, wherein said locking unit comprises a display being coupled to said outer wall of said box, said display being electrically coupled to said control circuit, said display displaying numeric indicia for indicating the time of day.

6. The assembly according to claim 5, wherein said locking unit comprises a plurality of control buttons, each of said control buttons being movably coupled to said outer wall of said box, each of said control buttons being electrically coupled to said control circuit, said control buttons being manipulated to program the time of day at which said control circuit should receive said unlock input.

7. The assembly according to claim 6, wherein said locking unit comprises a override button being movably coupled to said box, said override button being electrically coupled to said control circuit, said lock being actuated to release said lid when said override button is depressed.

8. The assembly according to claim 3, further comprising a power supply being coupled to said box, said power supply being electrically coupled to said control circuit, said power supply comprising:
at least one battery being electrically coupled to said control circuit; and
a charge port being recessed into said outer wall of said box, said charge port being electrically coupled to said at least one battery, said charge port being electrically coupled to a power source for charging said at least one battery.

9. A timed release storage assembly being configured to be openable only at predetermined intervals of time for controlled distribution of materials contained within, said assembly comprising:
a box having dimensions sufficient to receive a pack of cigarettes, said box having a top end and an outer wall, said top end being open;
a lid being hingedly coupled to said box, said lid being positionable between an open position and a closed position, said lid being positioned on said top end of said box, said lid closing said top end when said lid is in said closed position;
a locking unit being coupled to said box, said locking unit engaging said lid when said locking unit is in a locked condition wherein said locking unit is configured to restrict access to the pack of cigarettes in said box, said locking unit disengaging said when said locking unit is in an unlocked condition, said locking unit being actuated into said unlocked condition at predetermined intervals of time, said locking unit comprising:
a control circuit being coupled to said box, said control circuit receiving an unlock input;
a lock being coupled to said box, said lock being electrically coupled to said control circuit, said lock being in a normally locked condition thereby locking said lid, said lock being actuated to release said lid when said control circuit receives said unlock input;
an electronic timer being coupled to said box, said electronic timer being electrically coupled to said control circuit, said electronic timer tracking the time of day;
a display being coupled to said outer wall of said box, said display being electrically coupled to said control circuit, said display displaying numeric indicia for indicating the time of day;
a plurality of control buttons, each of said control buttons being movably coupled to said outer wall of said box, each of said control buttons being electrically coupled to said control circuit, said control buttons being manipulated to program the time of day at which said control circuit should receive said unlock input;
a override button being movably coupled to said box, said override button being electrically coupled to said control circuit, said lock being actuated to release said lid when said override button is depressed; and
a power supply being coupled to said box, said power supply being electrically coupled to said control circuit, said power supply comprising:
at least one battery being electrically coupled to said control circuit; and
a charge port being recessed into said outer wall of said box, said charge port being electrically coupled to said at least one battery, said charge port being electrically coupled to a power source for charging said at least one battery;
a lighter being coupled to said box, said lighter producing heat when said lighter is ignited wherein said lighter is configured to light cigarettes for smoking;
an igniter being slidably coupled to said box wherein said igniter is configured to be manipulated to a user, said igniter being operationally coupled to said lighter, said igniter turning on said lighter when said igniter is manipulated into an igniting position;
a light emitter being coupled to said box wherein said light emitter is configured to emit light outwardly therefrom, said light emitter being electrically coupled to said control circuit; and
a light button being movably coupled to said box, said light button being electrically coupled to said light emitter, said light button turning said light emitter on and off.
